(19) United States
(12) Patent Application Publication
(10) Pub. No.: US 2007/0289280 A1
(43) Pub. Date: Dec. 20, 2007

(54) SNAP-ON PADDLE AND METHOD OF CONVERTING A CONVENTIONAL PICKUP TINE INTO A PADDLE

(75) Inventor: Brandon J. Marquardt, Oregon, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: HCC, INC., Mendota, IL (US)

(21) Appl. No.: 11/762,463

(22) Filed: Jun. 13, 2007

Related U.S. Application Data
(60) Provisional application No. 60/805,247, filed on Jun. 20, 2006.

(51) Int. Cl. A01D 57/14

(52) U.S. Cl. 56/16.1

(57) ABSTRACT

A snap on paddle for effectively and quickly converting a fully intact, non-broken tine into a paddle such that, in use, an increased amount of crop is swept into a harvester combine. The snap on paddle includes a receptacle which is configured to engage the fully intact, non-broken tine. The receptacle consists of a generally open channel having a plurality of walls which contact different parts of the tine. A fin half is located proximate each side of the receptacle and tabs are provided for locking onto the bat of the tine. The paddle is configured such that the tine can be slipped in the receptacle and the tabs snap on the bat of the tine, thereby securing the paddle in place over the tine. As such, the paddle can be snapped onto a pickup tine without having to use any tools.

### BACKGROUND

The present invention generally relates to paddles for use with the reel of a harvester combine, and more specifically relates to a snap-on paddle. Another aspect of the present invention generally relates to methods of securing paddles to the reel of a harvester combine, and more specifically relates to a method of converting a pickup tine into a paddle.

A typical harvesting combine includes a pickup reel at its front end, where the reel rotates and effectively sweeps crop into the combine. The reel typically includes a plurality of horizontal tubes to each of which is attached a plurality of pickup tines. U.S. patent application Ser. No. 10/102,164 provides some background material on harvesters and harvester pickup reels and is hereby incorporated herein by reference in its entirety.

As shown in FIG. 1 of the present application, a conventional tine 10 is configured such that a clamp 12 is provided for clamping onto one of the tubes 14 of the pickup reel, and is fastened with a fastener 16, and at the opposite end is provided a long, extending finger 18 which is designed to sweep crop into the combine. Specifically, as the pickup reel rotates, the tine sweeps crop into the header of the combine.

Some harvesting applications are better performed using paddles in place of some of the tines on the pickup reel, as a paddle tends to feed more crop into the combine than a conventional tine. FIG. 2 illustrates a conventional paddle 20. As shown, a conventional paddle 20 also includes a clamp 22 for clamping onto one of the tubes 14 of the pickup reel, and is fastened with a fastener 16. Typically, in order to add some paddles to a pickup reel, one must remove some of the tines, and replace them with paddles. This process is time-consuming and requires that one use a tool. During the process, the combine remains out of service.

### OBJECTS AND SUMMARY

An object of an embodiment of the present invention is to provide a paddle which is configured to snap onto a pickup tine.

Another object of an embodiment of the present invention is to provide a paddle which is configured such that the paddle can be snapped onto a pickup tine without having to use any tools.

Still another object of an embodiment of the present invention is to provide a method of converting a pickup tine for a combine harvester reel into a paddle.

Briefly, and in accordance with at least one of the foregoing objects, an embodiment of the present invention provides a paddle which includes a receptacle which is configured to engage a fully intact, non-broken tine. The receptacle comprises a generally open channel having a plurality of walls which contact different parts of the tine. Specifically, a top wall may be provided to engage a top portion of the tine, a bottom wall may be provided to engage by the end of the tine, and an elongate wall may be provided to engage a main, middle portion of the tine. The paddle also includes a fin half proximate each side of the receptacle and tabs for locking onto the bat of the tine. The paddle is configured such that the tine can be slipped in the groove and the tabs snap on the bat of the tine, thereby securing the paddle in place over the tine.

### BRIEF DESCRIPTION OF THE DRAWINGS

The organization and manner of the structure and operation of the invention, together with further objects and advantages thereof, may best be understood by reference to the following description, taken in connection with the accompanying drawing, wherein:

FIG. 1 shows a conventional tine for use with the pickup reel of a harvesting combine, wherein the tine is clamped to a tube of the pickup reel;

FIG. 2 shows a conventional paddle for use with the pickup reel of a harvesting combine, wherein the tine is clamped to a tube of the pickup reel;

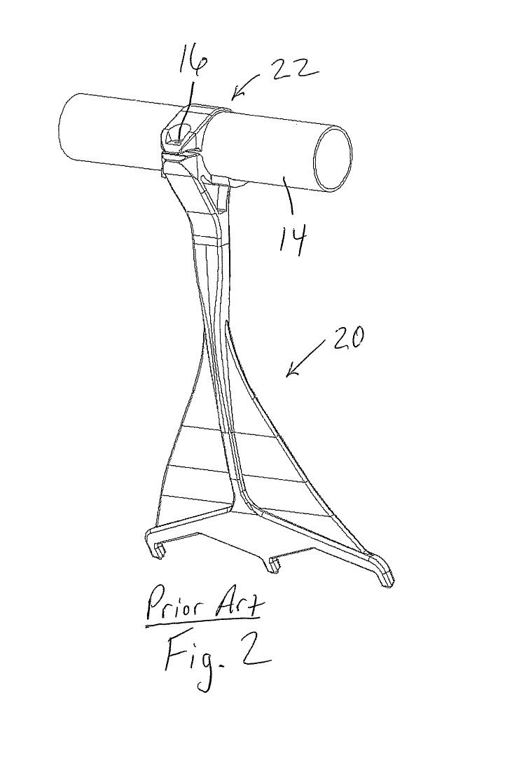

FIG. 3 illustrates a paddle which is in accordance with an embodiment of the present invention;

FIG. 4 illustrates the back side of the paddle shown in FIG. 3;

FIG. 5 illustrates the paddle of FIG. 3, snapped onto a conventional tine, thereby converting the tine into a paddle; and

FIG. 6 is similar to FIG. 5, but shows the back side.

### DESCRIPTION

While the invention may be susceptible to embodiment in different forms, there is shown in the drawings, and herein will be described in detail, a specific embodiment of the invention. The present disclosure is to be considered an example of the principles of the invention, and is not intended to limit the invention to that which is illustrated and described herein.

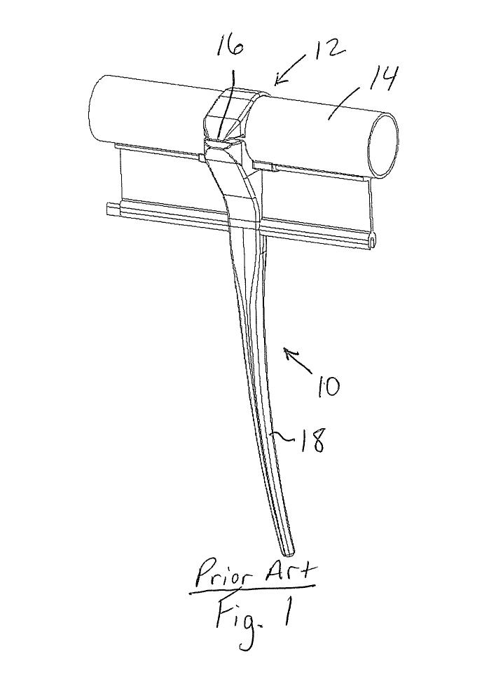

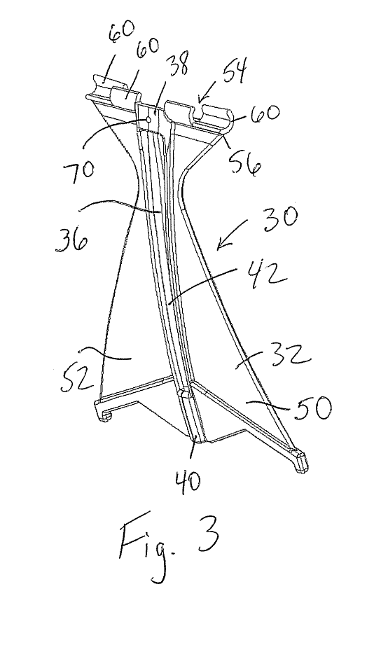

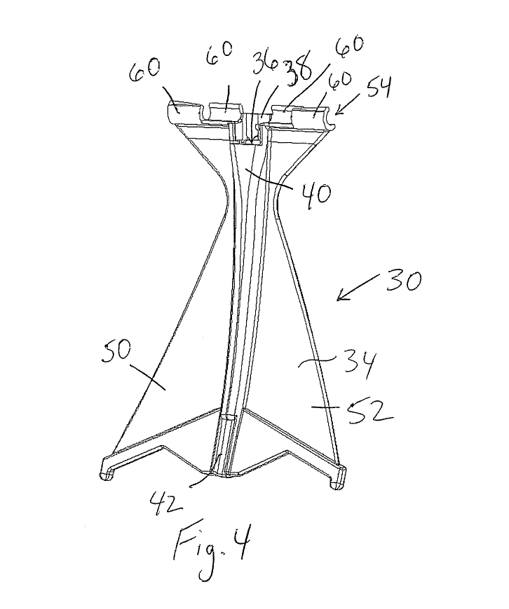

FIG. 3 illustrates a paddle 30 which is in accordance with an embodiment of the present invention. While FIG. 3 illustrates the front side 32 of the paddle 30, FIG. 4 illustrates the back side 34. The paddle is configured to snap onto a fully intact, non-broken pickup tine 10, such as is shown in FIG. 1, preferably without having to use any tools. As such, the paddle 30 provides that a pickup tine for a combine harvester reel can be quickly and easily effectively changed into a paddle.

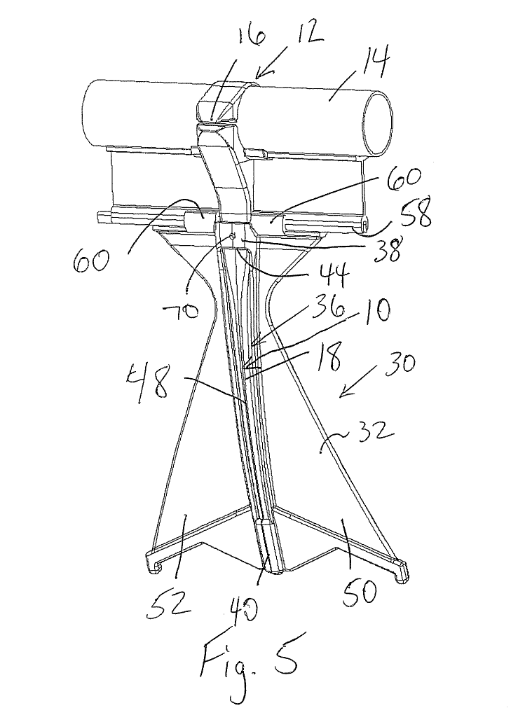

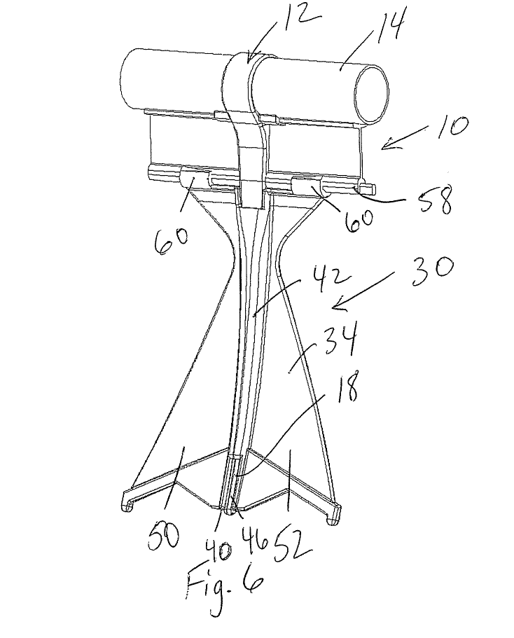

Preferably, the paddle 30 is made of a single piece of plastic or rubber and, as shown in FIGS. 3 and 4, includes a receptacle 36 which is configured to engage the fully intact, non-broken tine 10, such as is shown in FIGS. 5 and 6. As shown in FIGS. 3 and 4, the receptacle or groove 36 consists of a generally open channel having a plurality of walls 38, 40 and 42 which contact different parts of the tine 10. Specifically, the walls 38, 40, 42 may include a top wall 38 on the front 32 of the paddle which is configured to engage a top portion 44 of the tine 10, as shown in FIG. 5, and a bottom wall 40 which is configured to engage by the end 46 of the tine 10. In addition, as shown in FIGS. 4 and 6, there also may be provided an elongate wall 42 on the back 34 of the paddle 30 which is configured to engage a main, middle portion 48 of the tine 10.

The paddle 30 includes two fin halves 50, 52, one proximate each side of the receptacle 36, such that the receptacle 36 is disposed generally between the fin halves 50, 52. In use, the fin halves 50, 52 work to push short or sparse crops into the combine header. A groove 54 is provided at the top 56 of the paddle 30 for engaging the bat 58 of a tine 10, as shown in FIGS. 5 and 6, and tabs 60 are provided for snapping or locking onto the tine bat 58, thereby keeping the paddle 30 in place. The paddle 30 is configured such that the long, extending, fully intact, non-broken finger 18 of a tine 10 can be slipped in the receptacle 36 such that the walls 38, 40, 42 contact the finger 18 and the tabs 60 snap on the bat 58 of the tine 10, thereby securing the paddle 30 in place over the tine 10. As such, the paddle 30 can be snapped onto a pickup tine without having to use any tools. However, if desired or deemed necessary, a hole can be provided, such at location 70 shown in FIG. 5, for receiving a fastener for enhancing the securable engagement between the paddle 30 and the tine 10.

As such, the paddle 30 is configured to snap onto a fully intact, non-broken pickup tine 10, such as is shown in FIGS. 5 and 6, preferably without having to use any tools. As such, the paddle 30 provides that a pickup tine for a combine harvester reel can be quickly and easily effectively changed into a paddle.

While an embodiment of the present invention is shown and described, it is envisioned that those skilled in the art may devise various modifications of the present invention without departing from the spirit and scope of the foregoing disclosure.

What is claimed is:

1. A paddle for effectively converting a fully intact, non-broken tine of a combine harvester pickup reel into a paddle, said paddle comprising a receptacle which is configured to engage the fully intact, non-broken tine, the receptacle comprising a generally open channel having a plurality of walls which are configured to contact different parts of the tine, and a fin portion proximate each side of the receptacle.

2. The paddle as recited in claim 1, wherein the plurality of walls which are configured to contact different parts of the tine comprise a top wall which is configured to engage a top portion of the tine, a bottom wall which is configured to engage proximate an end of the tine, and an elongate wall which is configured to engage a main, middle portion of the tine.

3. The paddle as recited in claim 1, further comprising means for locking onto a bat of the tine.

4. The paddle as recited in claim 1, further comprising a groove at a top of the paddle and tabs at the top of the paddle which are configured to lock onto a bat of the tine.

5. The paddle as recited in claim 4, wherein the paddle is configured such that the tine is slippable in the receptacle and the tabs snap on the bat of the tine, thereby securing the paddle in place over the tine.

6. The paddle as recited in claim 5, wherein the paddle is configured such that the paddle is installable on the tine, and securable to the bat of the tine, without having to use tools.

7. The paddle as recited in claim 1, wherein the plurality of walls which are configured to contact different parts of the tine comprise a top wall which is configured to engage a top portion of the tine, a bottom wall which is configured to engage proximate an end of the tine, and an elongate wall which is configured to engage a main, middle portion of the tine, said paddle further comprising a groove at a top of the paddle and tabs at the top of the paddle which are configured to lock onto a bat of the tine, wherein the paddle is configured such that the tine is slippable in the receptacle and the tabs snap on the bat of the tine, thereby securing the paddle in place over the tine, wherein the paddle is configured such that the paddle is installable on the tine, and securable to the bat of the tine, without having to use tools.

8. A method of converting a fully intact, non-broken tine of a combine harvester pickup reel into a paddle, said method comprising: providing a paddle comprising a receptacle which is configured to engage the fully intact, non-broken tine, the receptacle comprising a generally open channel having a plurality of walls which are configured to contact different parts of the tine, and a fin portion proximate each side of the receptacle, said method further comprising slipping the tine into the receptacle of the paddle such that the tine is received in the receptacle of the paddle.

9. The method as recited in claim 8, further comprising securing the paddle to a bat of the tine.

10. The method as recited in claim 9, further comprising providing that the paddle comprises tabs at a top of the paddle, and said step of securing the paddle to the bat of the tine comprises snapping the tabs onto the bat.

11. The method as recited in claim 8, further comprising providing that the plurality of walls of the paddle comprise a top wall which is configured to engage a top portion of the tine, a bottom wall which is configured to engage proximate an end of the tine, and an elongate wall which is configured to engage a main, middle portion of the tine.

12. The method as recited in claim 9, further comprising providing that the paddle comprises a grove and tabs at a top of the paddle, and said step of securing the paddle to the bat of the tine comprises snapping the tabs onto the bat, such that at least a portion of the bat is received in the groove at the top of the paddle.

13. The method as recited in claim 9, wherein the step of securing the paddle to the bat of the tine comprises securing the paddle to the bat of the tine without using tools.

14. The method as recited in claim 8, further comprising providing that the plurality of walls of the paddle comprise a top wall which is configured to engage a top portion of the tine, a bottom wall which is configured to engage proximate an end of the tine, and an elongate wall which is configured to engage a main, middle portion of the tine, further comprising providing that the paddle comprises a grove and tabs at a top of the paddle, and said step of securing the paddle to the bat of the tine comprises snapping the tabs onto the bat, such that at least a portion of the bat is received in the groove at the top of the paddle, wherein the step of securing the paddle to the bat of the tine comprises securing the paddle to the bat of the tine without using tools.
